(19) United States
(12) Patent Application Publication
(10) Pub. No.: US 2025/0164937 A1
(43) Pub. Date: May 22, 2025

(54) Optical Measuring Method For Archimedian Flat Spirals And Spiral Springs With Optimized Geometry

(71) Applicant: Damasko Präzisionstechnik GmbH & Co. KG, Regensburg (DE)

(72) Inventor: Uwe Heinz, Manching (DE)

(21) Appl. No.: 18/533,783

(22) Filed: Dec. 8, 2023

(30) Foreign Application Priority Data
Jan. 3, 2023 (EP) 23150151.1
Jun. 15, 2023 (DE) 10 2023 115 667.5

(51) Int. Cl. G04D 7/00; G04B 17/06; G04D 7/10

(52) U.S. Cl. CPC G04D 7/004; G04B 17/066; G04D 7/10

(57) ABSTRACT

The invention relates to a spiral spring (100), suitable for use in an optical measuring method according to any one of the preceding claims, with several turns (110) which extend along respective circular paths forming a spiral course, wherein the spiral spring (100) can be stimulated to an oscillatory movement, in particular for clocking a mechanical movement, with adjacent turns (110) being deflected relative to each other along their respective circular paths by an angular displacement (β), It is the object of the present invention to determine the oscillation behavior of spiral springs based on characteristic geometries, and, in particular, to provide a non-invasive, non-contact measuring method which can be used in automated assembly lines in line assembly in movement production. The object is achieved in that the spacing (x) between the adjacent turns (110) varies at least along a measuring section corresponding to the angular displacement (β).

The invention relates to an optical measuring method for determining the oscillation width of a spiral spring with several turns, and a spiral spring for a mechanical movement, with a geometry optimized for the measuring method and the oscillation behavior.

Spiral springs in mechanical movements are Archimedean flat springs. The turns of the so-called spiral blade run spirally along respective circular paths in a common plane from an inner end of the turn to an outer end of the turn. The number of turns is typically between ten and fourteen, but spiral springs for mechanical movements with more or fewer turns are also known. The spacing between adjacent turns in spiral springs for mechanical movements is constant along the course of the spiral and usually ranges from 80.0 μm to 200.0 μm. In a mechanical movement, the spiral spring, together with the mass of an oscillating body, forms the oscillating and clocking oscillating system, also known as the balance wheel. Here, the exact rate of the clock is based on the spiral spring swinging back and forth around its tension-free central position as evenly as possible. During the oscillatory movement of the spiral spring, the individual turns move along their respective circular paths. This causes the spiral spring to contract and expand; this is referred to as the spiral spring “breathing”. The so-called oscillation width or amplitude corresponds to a full oscillation, i.e. a double deflection of the spiral spring from the central position in a first and a second, opposite direction and is therefore stated in angular degrees. For spiral springs for mechanical movements, the standard oscillation width is around 200°-300°.

The oscillation period or frequency depends largely on the moment of inertia of the balance wheel and is usually in the range of 1 to 5 oscillations per second. The oscillation width and frequency are crucial for the rate accuracy of the movement and must therefore be subject to no or only very small deviations from the intended target values. Spiral springs with oscillation behavior that is as constant and unchanged as possible therefore make a significant contribution to the quality of a mechanical movement.

Various materials and various processes for producing spiral springs are known from the prior art. The most common materials for spiral springs comprise glass, ceramics, carbons, metals and metal alloys, but also boron nitride, silicon carbide or diamond. Well-known manufacturing methods include winding, laser processing, casting and the like. In the recent past, the production of spiral springs from mono- or polycrystalline silicon using reactive ion etching has also become established. The best-known etching method for silicon components is the so-called DRIE method (Deep Reactive Iron Etch). Such etching methods are well-described in the prior art. Structures down to 2.5 nm can currently be imaged using photomasks. By adjusting the etching rate and choosing the technology for sidewall etching, the geometry of the spiral blade can be set. In this case, in principle, it is possible to etch surfaces with a roughness depth of less than 10 nm. Optionally, a coating can be applied after the etching process, which can also be used to impact the geometry of the spiral blade.

Thus, reactive ion etching of silicon can produce particularly high-quality components with precise geometry. For example, a spiral spring made of silicon for a mechanical movement is known from EP 3 452 874 B1, which was produced by reactive ion etching. The patent specification addresses the problem that, due to the excellent surface finish of the smooth side surfaces of the spiral blade, the turns thereof can stick together in the event of shocks to the movement or if it is handled poorly during assembly. In order to avoid such sticking together, a spiral spring is proposed whose spiral blade should have a cross-section that deviates from the usually rectangular shape. Specifically, the respective flanks or side surfaces should be straight and have low surface roughness, but should be inclined by a flank angle α of at least 2.5° relative to vertical. In radial section of the spiral blade, a trapezoidal shape results, with the upper and lower surfaces of the spiral blade being parallel to one another.

A spiral spring for mechanical movements is also known from WO 2014/203085 A1. The active oscillation section of this spiral spring ranges from the inner turn end, which adjoins a spiral spring fastening section, to the outer turn end, which has a spring holding point and is held by a holding element. In order to improve the oscillation behavior, the spiral spring should be formed geometrically in such a way that the mass is reduced and the moment of inertia of the balance wheel is positively impacted. For this purpose, the active oscillation section should have several subsections, with the height and/or width of the rectangular spiral blade of one subsection differing from the height and/or width of another subsection. Within the respective subsection, the height or width of the spiral blade is always constant. The different subsections can be created directly during the manufacture of the spiral spring. WO 2014/203085 A1 proposes etching the spiral spring out of a plate using an etching process. A photomask is to be applied to the surface of the plate, on which the structures or dimensions of the components to be etched are lithographically imaged.

Not only the mass, but also the geometry or configuration, in particular the configuration of the side surfaces of the spiral blade, impacts the moment of inertia and consequently the oscillation behavior of the spiral spring. Typically, the shape of the spiral spring therefore has a curvature that decreases evenly and steadily starting from the inner end of the turn towards the outer end of the turn.

Patent specifications EP 2 407 831 B1 and EP 2 887 152 B1 disclose spiral springs made of silicon, the shape of which is specified directly during production using etching methods and photomasks and deviates from the usual, uniform shape. According to EP 2 407 831 B1, the mass of the spiral blade should also be reduced in order to improve the moment of inertia. For this purpose, the spiral blade has a plurality of openings which, following the course of the turn, alternate with webs arranged in between and pass through the spiral blade along its height. According to a more specific embodiment, the spiral blade is shaped polygonally or has a serpentine shape. This is intended to improve the rigidity of the spiral blade in order to avoid breaks but also non-linear oscillation behavior caused by bending of the spiral blade.

A spiral blade with a polygonal shape is also proposed in EP 2 887 152 B1. The background here is again that the mutually facing side surfaces of the spiral blade should not stick to one another during the oscillatory movement. Thus, at least part of the spiral blade should be formed as a series of adjacent, prismatic or rectangular sections in order to obtain the desired polygonal shape.

The disadvantage of the shape deviating from the continuous curvature is that the resulting oscillation behavior cannot be reliably predicted, and such spiral blade shapes are therefore difficult to optimize. Even the smallest shape deviations can have a significant impact on the oscillation behavior.

Deviations in shape or the finish of technical surfaces are summarized under the term “shape deviations” and are divided into a 1st to 6th order system according to DIN 4760:1982-06. The shape is particularly relevant for the oscillation behavior of a spiral spring. This means whether the spiral blade, in particular its side surfaces, follow the usual, constantly decreasing curvature or, as described above, have a different, for example polygonal, shape. Deviations from the intended shape are often visible to the naked eye and are classified as first-order deviations or “shape deviations”. The surface finish that can be captured (only) metrologically is referred to as waviness, or 2nd order deviations and roughness, 3rd and 4th order deviations. Deviations in the microstructure and the lattice structure are ultimately assigned to the 5th or 6th order.

The waviness and roughness of a technical surface are provided in a waviness or roughness profile, which represents deviations from the target surface based on the wave depth Wₜ or roughness R_{z} captured metrologically. The roughness of a surface always follows the course of the waviness profile; the corresponding overlay of the roughness and waviness profile is shown in the so-called primary profile. Roughness and waviness are not defined by specified orders of magnitude. For example, the roughness depth of a technical surface can be greater than its wave depth. Instead, the intervals within which there are fluctuations in the wave depth or roughness depth between positive and negative values, i. e. crossing the zero line of the waviness or roughness profile or the surface target value, are used as the defining differentiation criterion. 3rd or 4th order shape deviations, i.e. roughness, always occur at much shorter intervals than 2nd order shape deviations, i.e. waviness. As already explained, this can be clearly seen from the overlay shown in the primary profile. Due to the short intervals within which the changes in the roughness depth occur, the roughness has a high impact on the resilience of the spiral spring.

International publication WO 2015/087252 A1 proposes a spiral spring whose spiral blade or “core” is etched from silicon and provided with a layer of silicon oxide or silicon dioxide by oxidation. The oxide layer is used for temperature compensation or the adjustment of the coefficient of thermal expansion (CTE) in order to enable uniform oscillation behavior that is independent of the temperature. In addition, the published patent application also describes that the surfaces, both of the core, the so-called “starting surface”, and of the coating, the so-called “finished outer surface” should have as little roughness as possible in order to avoid stress in the spiral spring and thereby any breaks. The preferred roughness depth R_{z} is specified as values between 0.01 μm and 2.0 μm for the starting surface and values between 0.001 μm and 2.0 μm for the finished outer surface.

Swiss patent CH 713 269 B1 discloses a spiral spring whose spiral blade has side surfaces with both a waviness profile, referred to here as a “macro-relief”, and a roughness profile following the course of the waviness profile, here referred to as a “micro-relief”. The spiral blade disclosed also includes a core made of silicon (Si) and a silicon dioxide (SiO₂) coating for temperature compensation. The macro and micro reliefs are formed on the side surfaces of the spiral blade to increase the ratio of silicon to the coating, i.e. Si/SiO₂, at selected turn length units, thereby locally adjusting the temperature compensation. A wave depth is specified for the macro-relief, which should be greater than 0.1 times the width of the spiral blade, while the roughness depth of the micro-relief should be less than 0.01 times the width of the spiral blade. A wave depth that corresponds to a tenth or more of the width of the spiral blade is relatively high and can have an impact on the oscillation behavior of the spiral spring and thus on the quality and rate accuracy of the movement.

After being produced, the oscillation behavior of the spiral springs during assembly and fine adjustment is checked as part of quality control. For this purpose, a structure-borne sound measurement is usually carried out using a structure-borne sound microphone and displayed graphically. This measuring process is not automated and is therefore comparatively time-consuming.

It is the object of the present invention to determine the oscillation behavior of spiral springs, in particular with an Archimedean and/or logarithmic course, based on characteristic geometries, and, in particular, to provide a non-invasive, non-contact measuring method which can be used in automated assembly lines in line assembly in movement production, and thus enables and ensures the production of spiral springs with optimized oscillation behavior.

The object is achieved by an optical measuring method according to claim 1, and by a spiral spring with a geometry optimized for the measuring method and the oscillation behavior, in particular configuration of the side surfaces of the spiral blade according to claim 6.

In an optical measuring method according to the invention, a deflection of adjacent turns relative to one another and along their respective circular paths is optically captured in a dynamic manner in at least one turn section, i.e. during the oscillatory movement of the spiral spring, based on a variance of the spacing between the adjacent turns along the turn section. Unlike in the prior art, for the optical measuring method according to the invention, the spacing between adjacent turns along a turn section or along the spiral course should not be constant, but should vary. For optical capture, at least one turn section is specified, within which the variance of the spacing between the adjacent turns is at least 0.02%, at least along a measuring section corresponding to the angular displacement.

The measuring method preferably follows immediately after the assembly of the movement, so that the spiral spring is measured in the assembled state while still on the assembly line. This means that the outer and inner turn ends are already assembled with the corresponding holding elements of the oscillation system and are therefore fixed. For the optical measuring method, the active oscillation section of the spiral spring is caused to oscillate, causing the individual turns to move back and forth along their circular paths around the center of the spiral spring or the axis of rotation of the oscillating body. Adjacent turns are subject to a relative movement, which results in a deflection of the turns relative to one another.

According to the invention, this deflection of two adjacent turns relative to one another is captured without contact using optical measuring equipment, for example for recording the movement or by means of laser measurement or laser scanning. The spacing between the turns serves as a benchmark or reference for the optical measuring equipment. For this purpose, the spacing in the longitudinal direction of the turns, i.e. following the spiral course, must not be constant, otherwise the relative movement would not be optically detectable. A “visualization” of the relative movement or deflection of adjacent turns relative to one another is achieved by varying their spacing along the turn section, due to the component geometry of the spiral spring. The varying spacing due to the component geometry results in an optimized scanning option for contour recognition for the optical measuring equipment in order to be able to accurately capture the degree of deflection of adjacent turns relative to one another at any time during the oscillatory movement.

Based on the optically captured maximum deflection, i.e. when the oscillatory movement reaches its reversal point, i.e. the neighboring turns execute a reverse, relative movement, the resulting angular displacement of the adjacent turns relative to one another is then determined in angular degrees. Typical values for the angular displacement of spiral springs for mechanical movements range from 5° to 30°.

Finally, based on the angular displacement, the oscillation width and/or the oscillation frequency of the spiral spring is determined mathematically. When the spiral spring oscillates, the radial angular path or the angular displacement of the individual turns of the spiral spring from outside to inside, e.g. when contracting, becomes smaller and smaller, this deviation can be measured dynamically. The spacings between the turns also change when breathing, i.e. the periodic contraction or expansion of the spiral spring. Unlike the variance of the spacing according to the invention, this change is not caused by the component geometry, in particular the geometry of the turn sections, but by the oscillatory movement itself and is undetectable in the rest position. This breathing of the spiral spring is known or can be measured and should be taken into account when calculating the oscillation width and/or the oscillation frequency. For the average spacing, which, according to the invention, should vary due to the component geometry, in particular the configuration of the side surfaces of the spiral blade, the spacing between the turns in the rest position of the spiral spring is therefore preferably not taken as a basis, but rather the spacing of the spiral spring, which changes dynamically during the oscillatory movement.

The target value of the angular displacement also specifies the length of the measuring section, which at least corresponds to the angular displacement. An angular displacement in a range between 5° and 30° results in a measuring spacing of at least 100.0 μm to 900.0 μm in length.

The evaluation of the optical measurement signals and the mathematical determination of the oscillation width are preferably automated and integrated into the assembly line of a line assembly in movement production. For this purpose, the signals captured by the optical measuring equipment are transmitted to a control module. Using programming stored on an electronic data carrier of the control module, the angular displacement is determined from the optical measurement signals received, and the oscillation width is determined mathematically. For the calculation, other values can be taken into account in the programming, such as, for example, the number of turns of the spiral spring, the deviation of said turns from the Archimedean course and/or logarithmic course, the radial position of the monitored turn section, moment of inertia, breathing of the spiral spring, etc., and stored on the data carrier for this purpose. Furthermore, the control module can of course also access other target values stored for the production of the spiral spring, for example the height and width of the spiral blade, but also the angular displacement to be achieved, on the basis of which the length of the measuring section is determined.

Here, it is advantageous not to optically monitor the entire course of the spiral spring, but rather a pre-specified turn section. In doing so, the amount of equipment involved in the measuring process can be reduced, as a result of which the optical measuring equipment requires less space and can therefore be positioned more easily in the area of the spiral spring pre-assembled in the movement. Particularly advantageously, the turn section used for the optical capture of the varying spacing is already specified for the production of the spiral spring and configured with the desired variance of the spacing.

In principle, the higher the variance, the more accurately and easily and with correspondingly less effort the deflection of the adjacent turns relative to one another can be captured using optical measuring equipment. However, the variance must not be too high to rule out the possibility that neighboring turns could touch each other during the oscillatory movement or that the deviations themselves impact the oscillation behavior of the spiral spring. With an exemplary spacing between two adjacent turns of 100.0 μm and a minimum variance of 0.02%, the spacing would vary by at least +/−0.02 μm around the mean of 100.0 μm, i.e. the maximum and the minimum spacing between the turns ranges from 100.02 μm (100.0 μm+0.02 μm) to 99.98 μm (100.0 μm-0.02 μm) and deviates by at least 0.04 μm along the measuring path.

With an exemplary spacing between two adjacent turns of 100.0 μm and a minimum variance of 0.04%, the spacing would vary by at least +/−0.04 μm around the mean of 100.0 μm, i.e. the maximum and the minimum spacing between the turns ranges from 100.04 μm (100.0 μm+0.04 μm) to 99.96 μm (100.0 μm-0.04 μm) and deviates by at least 0.08 μm along the measuring path. Such variances can be captured optically using modern measuring methods and can be used as a reference or benchmark for monitoring the relative movement and consequently the deflection of two adjacent turns to one another.

Advantageous embodiments are claimed in the dependent claims and are explained in more detail below.

According to an advantageous design of the invention, for the optical capture of the deflection of adjacent turns relative to one another, at least one turn section can be specified, within which the variance of the spacing between the adjacent turns is at least 0.025%, 0.04%, 0.05% or 0.1%, more preferably at least 0.25% or 0.3% and preferably at most 1.5%, and more preferably at most 1.0%, along a measuring section corresponding to the angular displacement.

Because the turns move relative to one another in the oscillatory movement, it is advantageous according to a variant of the invention to optically capture the deflection of adjacent turns relative to one another based on the spacing between the neighboring turns, which varies steadily or continuously at least along a measuring path corresponding to the angular displacement. With a continuous variance or change in the spacing, i.e. a continuous increase or decrease or a continuous change between increase and decrease in the spacing, a continuously changing optical measurement signal or image is obtained during optical capture. This considerably simplifies the evaluation of the optical measurement signal to determine the maximum deflection, i.e. the point at which the oscillatory movement reverses. At the same time, the susceptibility to errors is reduced. Based on a continuous variance, spacing patterns that are characteristic of the respective positioning of the turns relative to one another can be determined using software, based on which, for example, the direction of the oscillatory movement and/or the degree of deflection of adjacent turns relative to one another can be clearly determined at any time. It has also proven to be an advantage that the spacing, which varies continuously, is subject to a steady change, i.e. varies steadily. This avoids peaks or “outliers” in the optical measurement signal.

In principle, it is conceivable to define the spacing between adjacent turns as the connecting line that strikes the mutually facing side surfaces of the adjacent turns orthogonally. In order to generate the variance in spacing required for the optical measuring method, the geometry of the spiral spring or spiral blade is changed so that the side surfaces do not follow the usually vertical course. Preferably, the spacing is therefore defined as a radial spacing between the adjacent turns, i.e. along a radius of the spiral spring starting from a side surface of one of the turns towards the opposite side surface of the other turn.

Because of the changed, optimized geometry of the spiral blade, it may be necessary, according to an equally advantageous variant of the invention, to capture the variance of the spacing between the adjacent turns along the turn section at a measuring height defined in relation to the height of the spiral blade, in particular the adjacent turns. The measuring height can, for example, correspond to a fraction, in particular half, of the height of the adjacent turns but also to the upper or lower longitudinal edge, and depends on the specific geometry of the mutually facing side surfaces of the adjacent turns, which brings about the variance in the spacing.

The measuring height is therefore specified based on the geometry of the spiral blade, in particular the mutually facing side surfaces. Corresponding data regarding the specific geometry of the spiral blade, at least in a turn section of the spiral spring, can, for example, be stored on an electronic data carrier and then used to set the parameters in the optical measuring method.

In order to accurately capture the spacing between adjacent turns, it is particularly advantageous according to a design of the invention that optical measuring equipment provided for the optical capture, in particular light source(s) and/or light receivers, is aligned straight from above or below, i.e. parallel to the axis of the spiral spring or alternatively, obliquely, enclosing an angle greater than or less than 90° with the axis of the spiral spring, with the turn section to be monitored or the neighboring turns.

The optical measuring method and, optionally, downstream (image) evaluation software enable highly precise, direct monitoring of movement sequences. During the oscillatory movement along the monitored turn section, the adjacent turns of the spiral spring have an image pattern that is characteristic due to the varying spacing, which serves as a benchmark or reference for the (image) evaluation software. Measuring methods suitable for the optical measuring method and adequately described in the prior art include, for example, laser Doppler vibrometry, laser interferometric vibrometry, white light interferometry, also with a confocal microscope, 2D/3D laser scanning, high-resolution digital microscopy with video function, and/or combined laser light—and white light microscopy for 2D/3D scanning. White light interferometry is a purely optical measuring method that records up to a million images per second. A downstream software or stored programming can determine the deflection or the maximum deflection or angular deviation of the adjacent turns from one another based on the irregularities that result from the variance of the spacing. In laser interferometry, for example, the geometry or the spacing between the adjacent turns is scanned or sampled using a laser at 1 million points per second.

The measuring methods mentioned above can be utilized alone or in combination. Particularly in combination, a highly precise, qualitative statement can be made about the oscillation behavior of the spiral spring and starting points for targeted interventions can be identified.

Because of the measurement value recording and evaluation within seconds, the method according to the invention can be utilized particularly in automated assembly lines in line assembly in movement production. Testing and comcomitant regulation of the spiral spring can be carried out fully automatically. The method is also very suitable for pre-regulating entire oscillatory systems as a single-user measurement. The measuring system displays the oscillation width, frequency and rate of the clock directly on the spiral or on a defined turn section. Any interferences such as natural frequencies and deflections from the spiral plane during the oscillation are also made visible. These measurements take place within a few seconds.

If necessary, as part of quality control and in particular to determine the rate accuracy of a mechanical movement, the oscillation frequency can be determined based on the oscillation period of the spiral spring using an optional method variant. A one-time deflection of two adjacent turns relative to each other by the angular deviation corresponds to a half-oscillation of the spiral spring. By measuring the time required for this, the number of half-oscillations or complete oscillations (i.e. two half-oscillations) per unit of time and consequently the oscillation frequency can be determined.

Finally, according to an advantageous variant of the method according to the invention, the rate accuracy or a rate deviation or a rate error of a mechanical movement can be based on the determined oscillation width and/or frequency. For this purpose, a target value/actual value comparison is carried out, wherein the determined oscillation width and/or frequency corresponds to the actual value and this actual value is compared with a corresponding, pre-specified target value. Preferably, the target value data for carrying out the optical measuring method in an automated manner can be stored in advance on an electronic data carrier of a control module suitable for carrying out the measuring method.

Preferably, a geometry of the spiral blade of the spiral spring that is optimized for the measuring method according to the invention is already taken into account during its production, i.e. the spiral spring can be produced with at least one turn section, which is suitable for optically capturing the relative deflection of adjacent turns due to the geometry of the mutually facing side surfaces. For this purpose, the geometry of the side surfaces is formed such that the spacing between the adjacent turns varies along the turn section. Corresponding data regarding the specific geometry of the spiral blade, at least in one turn section, can be stored on an electronic data carrier for an automated manufacturing and measuring method and can be made available both to specify corresponding parameters in the optical measuring method, such as measuring height or spacing definition, as well as to specify the parameters for the production of the spiral spring.

The object of the invention set out at the beginning is therefore also achieved by a spiral spring which is suitable for use in the optical measuring method according to the invention and whose geometry, in particular the configuration of the spiral blade for this purpose, is optimized with regard to its oscillation behavior.

Such a spiral spring according to the invention has several turns which extend along respective circular paths forming a spiral, in particular Archimedean and/or logarithmic course, and can be stimulated to an oscillatory movement, in particular for clocking a mechanical movement, with adjacent turns being deflected relative to each other along their respective circular paths by an angular displacement. The spiral spring according to the invention is characterized in that the spacing between the adjacent turns varies at least along a measuring section corresponding to the angular displacement β, the variance of the spacing (x) between the adjacent turns (110) being brought about by the configuration of the mutually facing side surfaces (131) of the adjacent turns (110) of the spiral spring (100), and is at least 0.02% and at most 1.5% along the measuring section.

Unlike the spiral springs known from the prior art, in which the spacing between adjacent turns along the longitudinal extent, i.e., following the course of the spiral, is constant, the spiral spring according to the invention has a varying or variable spacing.

In order to facilitate the capture of the oscillatory movement and the relative deflection that takes place between adjacent turns during the oscillation, using optical measuring equipment or measuring methods, the variance of the spacing between the adjacent turns along the measuring section is preferably at least 0.025%, 0.04%, 0.05% or 0.1%, more preferably at least 0.25% or 0.3%. The higher the variance, the more precisely the relative deflection can be captured using optical equipment and the more reliable are the determined values for oscillation width and/or frequency. In order to ensure that the oscillation behavior of the spiral spring in the movement continues to be uniform and, in particular, to prevent the adjacent turns from touching each other during the oscillatory movement, the variance is at most 1.5% and preferably at most 1.0%. Each of the value ranges mentioned for the variance of the spacing represents a viable compromise between, on the one hand, suitability as a reference or benchmark for optical measuring equipment for dynamically capturing the angular displacement and, on the other hand, a spiral spring with optimized oscillation behavior for use in mechanical movements.

The spacing between the adjacent turns can vary not only along the course of the turns or the measuring section, but, according to an advantageous design variant, also along the height of the mutually facing side surfaces of the spiral spring, whereby additional benchmarks or reference points are provided for the optical measuring method. Along the height, the variance of the spacing between the adjacent turns is at least 0.01% and at most 2.0%. Preferred values for the variance of the spacing are at least 0.015%, 0.02%, 0.03% or 0.05%, more preferably at least 0.125% or 0.15%, and at most 1.5% or 1.0%. Both along the course of the turn and along the height, the specific variance values are influenced by the configuration of the mutually facing side surfaces of the spiral spring bringing about the variance.

Typically, the spacing between turns of a spiral spring for mechanical movements is constant along the entire course of the spiral and is in most cases 80.0 μm to 200.0 μm. A spacing of 80.0 μm between the turns, for example, results in a deviation of +/−0.016 μm around the mean value when a variance is at least 0.02%. This in turn results in a range of 80.016 μm (=80.0 μm+0.016 μm) to 79.084 μm (=80.0 μm-0.016 μm), within which the spacing along the measuring section or the course of the turn and preferably also along the height should vary at least.

To the contrary, a spacing of 200.0 μm between the turns, for example, results in a deviation of +/−3.0 μm around the mean value when a variance of at most 1.5%. This in turn results in a range of 203.0 μm (=200.0 μm+3.0 μm) to 197.0 μm (=200.0 μm-3.0 μm), within which the spacing along the measuring section or the course of the turn and preferably also along the height should vary at most.

Alternatively or optionally, the spacing along the measuring section can (also) vary continuously or steadily.

The varying spacing is brought about by the geometry or the configuration of the mutually facing side surfaces of the adjacent turns of the spiral spring. According to a preferred design of the invention, the geometry is impacted by the configuration of the surface finish of one or both of the mutually facing side surfaces, which are configured with waviness bringing about the variance of the spacing.

The waviness, i.e. a 2nd order shape deviation of the mutually facing side surfaces, can be better utilized for the dynamic capture with optical measuring equipment than the roughness, i.e. a 3rd or 4th order shape deviation, due to the changes in the wave depth that occur at larger intervals. Due to the much smaller intervals within which the changes in the roughness depth in the roughness profile occur, these changes tend to blur in the imaging dynamic measuring method, during which the turns of the spiral blade move relative to one another at a frequency of 1 to 5 oscillations per second. The changes in wave depth Wₜ that occur at larger intervals are significantly easier to dynamically capture using optical equipment, which means that the oscillation width and/or frequency can be evaluated more reliably. Corresponding to the larger intervals, the measuring section along which the waviness is optically captured, must be based on a minimum dimension. A measuring section that is at least 50.0 μm long, or better yet at least 100.0 μm, can be sufficient. Preferably, the waviness is captured along a measuring section corresponding to the angular deviation, with a waviness profile of the opposite side surfaces of the spiral blade along a turn section corresponding to the angular deviation proving to be advantageous.

Typically, it is advantageous to design both of the mutually facing side surfaces with waviness, because in this case the maximum wave depth Wₜ can be chosen so as to be smaller in order to achieve the desired variance in the spacing. However, if only one of the two side surfaces is formed with waviness, then this waviness should be chosen so to be at least twice as high.

In this case, the surface finish of the mutually facing side surfaces can have waviness along the course of the turn and/or along the height, that is, the respective waviness profile extends over a turn section corresponding to the measuring section or partially or entirely over the height of the side surface of the spiral blade.

By configuring the mutually facing side surfaces of the spiral blade with waviness in order to bring about the variance of the spacing, the roughness of the side surface, i.e. the values for the roughness depth, can at the same time be chosen to be low in order to reduce stresses within the spiral blade and consequently minimize the risk of breakage of the spiral blade. A roughness depth value R_{z} of one or both mutually facing side surfaces of at most 0.5 μm turned out to provide a suitable roughness profile, but the roughness depth value is preferably lower, in particular between 0.5 μm and 0.005 μm.

According to an exemplary variant of the invention, in particular in order to realize the desired values for the variance of the spacing resulting from the surface finish or geometry and at the same time to realize the lowest possible roughness of the side surfaces of the spiral blade, the spiral spring is made of silicon, preferably monocrystalline or polycrystalline silicon by means of an etching process and optionally provided with a silicon oxide or silicon dioxide coating.

The desired waviness profile bringing about the variance of the spacing can then optionally or as needed be configured on the surface or the side surfaces of the core of the spiral spring and/or on the coating covering the side surfaces. The dynamic, optical capture of the surface finish then takes place accordingly on the coating and/or on the core of the spiral spring, for example by means of interferometry, which is also utilized in semiconductor technology to determine layer thickness.

According to an exemplary variant of the invention, the geometry of the mutually facing side surfaces is configured such that the spacing between the turns varies either over the entire height of the spiral blade, or only at a certain height or a certain height range along the measuring section.

Preferably, the height of the spiral blade is constant along the entire course of the spiral and ranges, for example, from 80 μm to 160 μm. The width of the spiral blade, which is usually around 25 to 45 μm, is basically constant along the entire course of the spiral. However, due to the changed geometry of the mutually facing side surfaces, deviations occur which correspond to the variance of the spacing between the adjacent turns.

In a preferred design of the invention, the spacing between the adjacent turns, for example in the area of the lower longitudinal edge, can deviate from the spacing between the adjacent turns in the area of the upper longitudinal edge of the mutually facing side surfaces, the spacings in the area of the upper longitudinal edge and/or in the area of lower longitudinal edge varying along the measuring section. In particular, the spacing in the area of one of the longitudinal edges, preferably the upper longitudinal edge, can be constant along the entire spiral course and can vary in the area of the other longitudinal edge, preferably the lower longitudinal edge, at least along the measuring section. This can then result in a likewise constant width of the spiral blade in the area of the upper longitudinal edge and a width of the spiral blade in the area of the lower longitudinal edge that deviates according to the variance of the spacing at least along the measuring section. The designation “upper” and “lower” longitudinal edge refers to the installation position of the spiral spring or the movement in a chronograph, viewed from the back in the direction of the dial.

According to a design variant of the spiral spring according to the invention, the mutually facing side surfaces are configured to include an opening angle in between, the opening angle varying along the measuring section, bringing about the variance of the spacing.

Normally, the spiral blade of a spiral spring has a rectangular cross section, with the height of the spiral blade parallel to its axis of rotation. The opening angle can be formed by an oblique course of one or both side surfaces over the height, i.e. the course of the side surface(s) is then no longer parallel to the axis of rotation. The average opening angle can in principle be 0°, but preferably ranges from 1.0° to 20.0°, more preferably from 1.0° to 10.0°, or particularly preferably from 1.0° to 7.00. Alternatively, the opening angle is at least 2.0° or at least 3.0° and then ranges, for example, from 2.0° to 10.0°, preferably from 2.00 to 7.0°, or particularly preferably from 3.0° and 5.0°. In order to bring about sufficient variance in the spacing between the adjacent turns, a variance in the opening angle is at least 0.1°, at least along the measuring section.

For an opening angle of, for example, 3°, there is a deviation of +/−0.1° around the mean with a variance of at least 0.1°. This in turn results in a range of 3.1° (=3.0°+0.1°) to 2.9° (=3.0°-0.1°), within which the opening angle along the measuring section or the course of the turn should vary at least.

Particularly advantageous, both for the optical measuring method and in terms of oscillation behavior, is a spiral spring in which the variance of the spacing between adjacent turns is brought about by a combination of the opening angle varying along the measuring section and waviness along the course of the turn and/or along the height of one or both of the mutually facing side surfaces. That is to say that, on the one hand, the opening angle varies along the course of the turn or along the measuring section, and there is a respective partially or entirely varying waviness profile over a turn section corresponding to the measuring section and/or over the height of the side surface of the spiral blade.

A design variant is comparatively easy to produce, in which the opening angle is formed by an oblique course of one or both side surfaces with respect to the height, and varies along the measuring section, i.e. along the course of the turn, and at the same time the waviness varies along the height, i.e. the oblique course of the side surface. The zero line of a waviness profile derived therefrom then corresponds to the height that runs obliquely to the axis of rotation in the cross section of such a spiral blade.

According to other design variants of the spiral spring according to the invention, the mutually facing side surfaces can be formed to follow a concave and/or convex course over the height and/or to have a rounded or beveled transition area in the area of the upper and/or lower longitudinal edge, the concave course and/or the rounding or bevelling of the transition area along the measuring section varying.

A concave and/or convex course of the side surface can optionally be formed on one or both side surfaces, with the course extending either over the entire height or only a subsection of the height. A beveled and/or rounded transition area is formed on the upper and/or lower longitudinal edges of one or both side surfaces. In order to bring about sufficient variance in the spacing, a variance in the transition area along the measuring section is preferably at least 10%, 20% or 25%, in particular at least 40%. An edge rounding of 2.0 μm, for example, results in a deviation of +/−0.5 μm around the mean with a variance of at least 25%. This in turn results in a range of 1.5 μm (2.0 μm-0.5 μm) to 2.5 μm (2.0 μm+0.5 μm), within which the edge rounding along the measuring section or the course of the turn varies at least.

According to an alternative design of the invention, the spacing between the adjacent turns is the same over the entire height of the mutually facing side surfaces and varies along the measuring section. For example, a continuously or steadily varying or irregular course of the upper and lower longitudinal edges along the measuring section can continue into the corresponding side surfaces, so that a spacing between the adjacent turns that is constant over the height of the spiral blade and varies along the measuring section is generated. This has the advantage that the spacing can be captured optically at any measuring height, which means that the recording of measured values is clearly secured.

According to a preferred variant of the invention, the geometry of the mutually facing side surfaces of the turns in the area of the upper and/or lower longitudinal edges is formed such that the longitudinal edge(s) has/have an irregular or varying course, at least along the measuring section.

Of course, a combination of one, several or all of the previously described exemplary embodiments is also conceivable in order to bring about the minimum variance in the spacing required for dynamic, optical capture.

Finally, for the oscillation behavior and the breakage resistance of the spiral spring, it can be advantageous if, according to an exemplary design, it has a spiral blade whose shape, in particular its side surfaces, follows a curvature that steadily decreases from the inner end of the turn to the outer end of the turn and/or which is solid.

Further details, features, feature sub(combinations), advantages and effects based on the invention will be apparent from the following description of a preferred exemplary embodiments of the invention and from the drawings. In the drawings

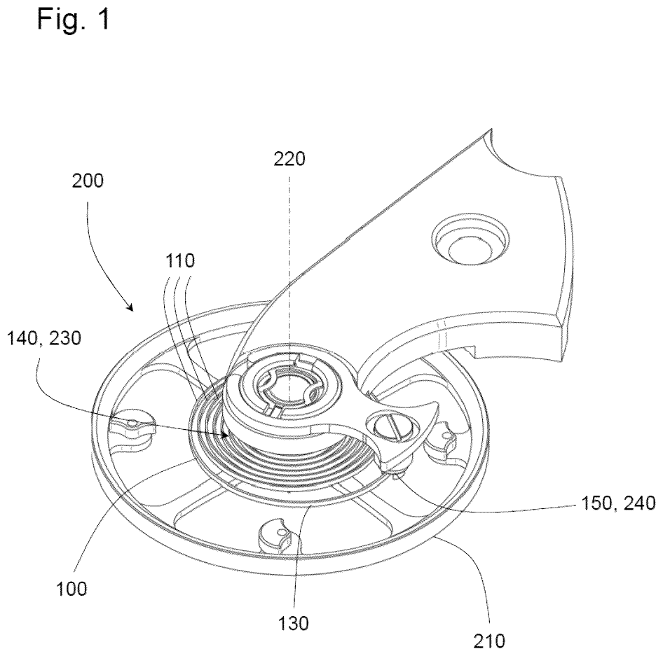

FIG. 1 shows a perspective representation of an oscillatory system of a mechanical movement known from the prior art, with a spiral spring,

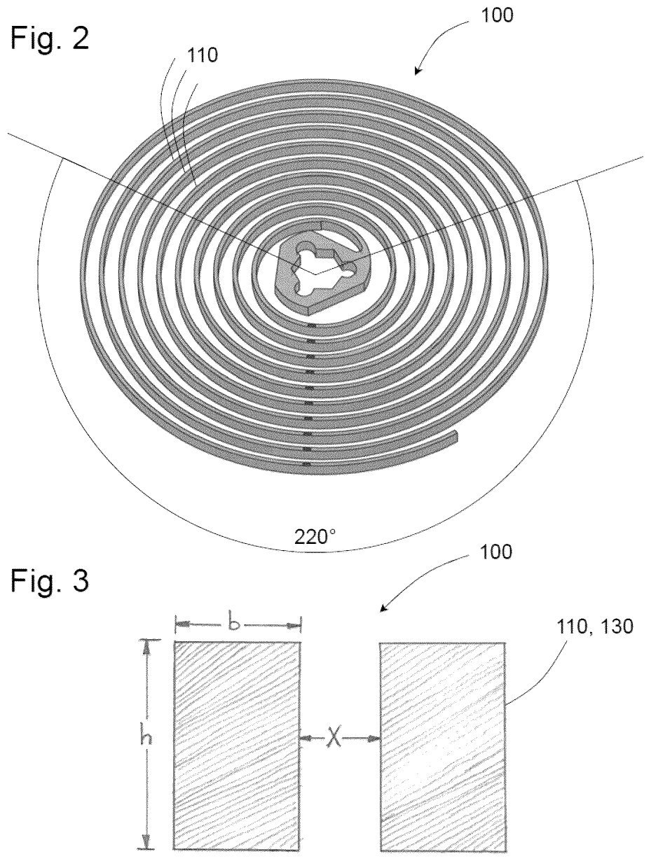

FIG. 2 shows a perspective representation of the spiral spring of FIG. 1 in a tension-free central position,

FIG. 3 shows a schematic, radial sectional view of two adjacent turns of the spiral blade of the spiral spring of FIGS. 1 and 2,

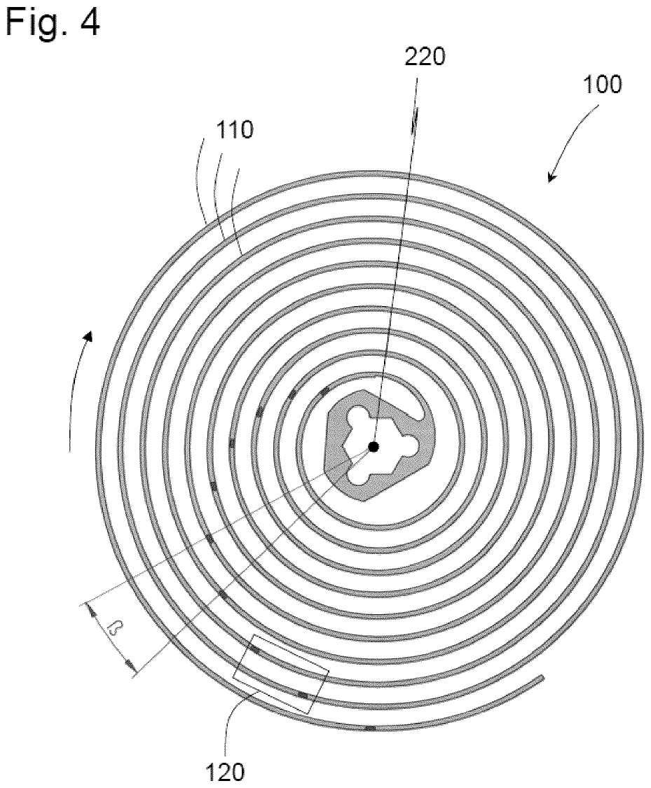

FIG. 4 shows a top view of the spiral spring of FIGS. 1 to 3 in a position deflected by half the oscillation width,

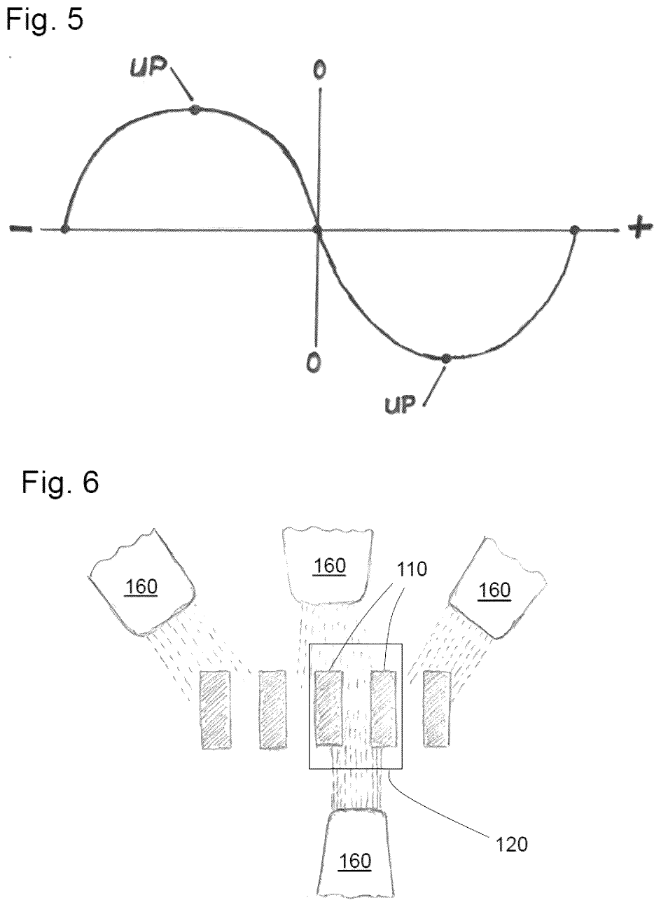

FIG. 5 shows an exemplary plot of the course of oscillation of a spiral spring,

FIG. 6 shows a schematic, radial sectional view of several adjacent turns of the spiral blade of the spiral spring of FIGS. 1 to 4, with measuring equipment positioned thereon, according to a method variant according to the invention,

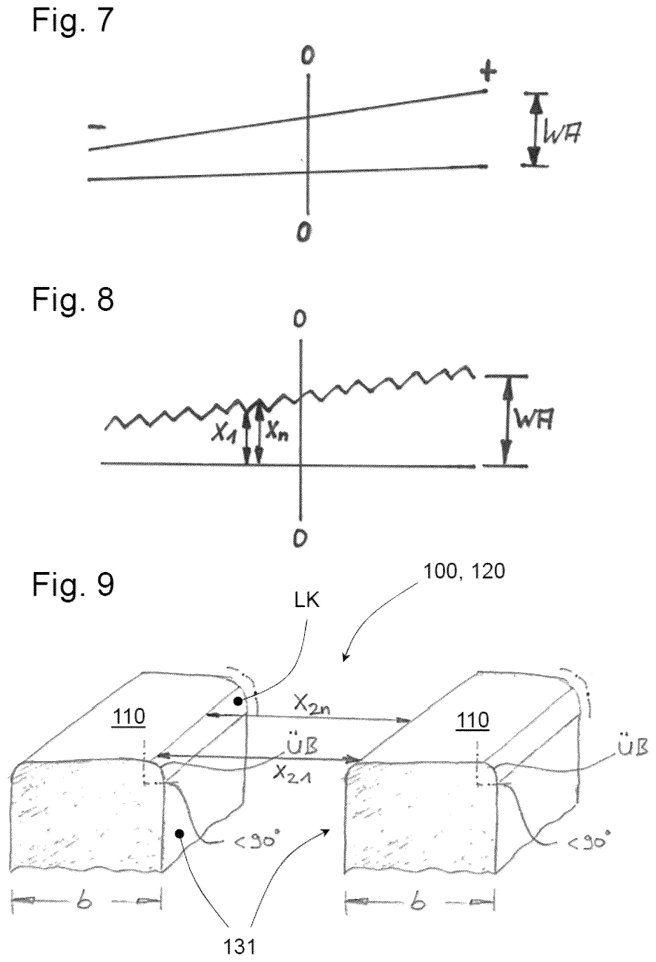

FIG. 7 shows schematic representation of the oscillation-related change in the turn spacing during the oscillatory movement of a spiral spring,

FIG. 8 shows a schematic representation of the oscillation-related change in the turn spacing overlayed with an exemplary variance of the spacing according to the invention caused by the component geometry,

FIG. 9 shows a schematic perspective representation of a turn section with two adjacent turns according to a first embodiment of the invention, with a spacing varying in a transition area,

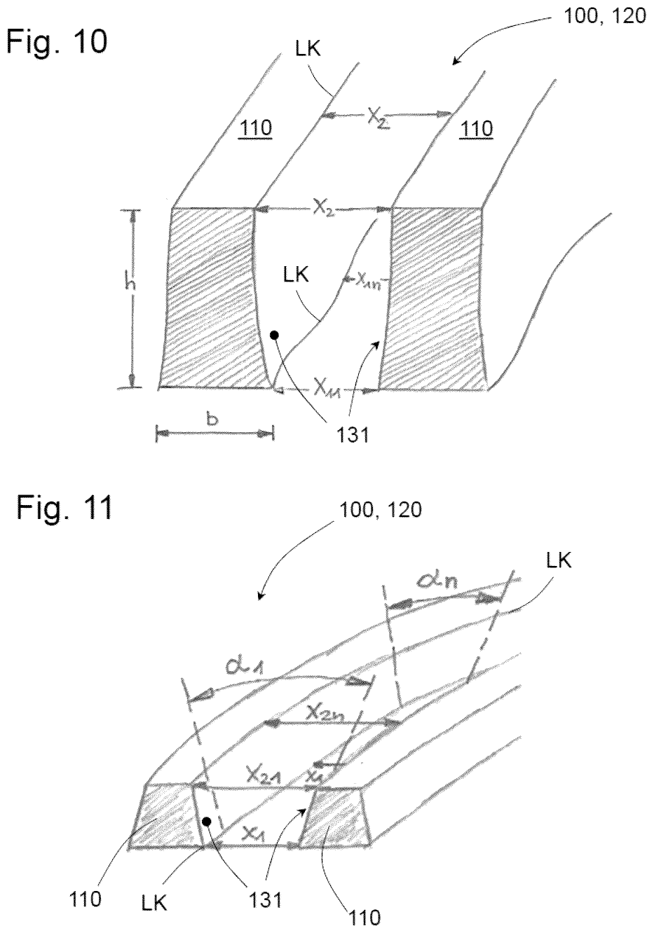

FIG. 10 shows a schematic perspective representation of a turn section with two adjacent turns according to a second embodiment of the invention, with a concave geometry of the side surfaces,

FIG. 11 shows a schematic perspective representation of a turn section with two adjacent turns according to a third embodiment of the invention, with varying opening angle,

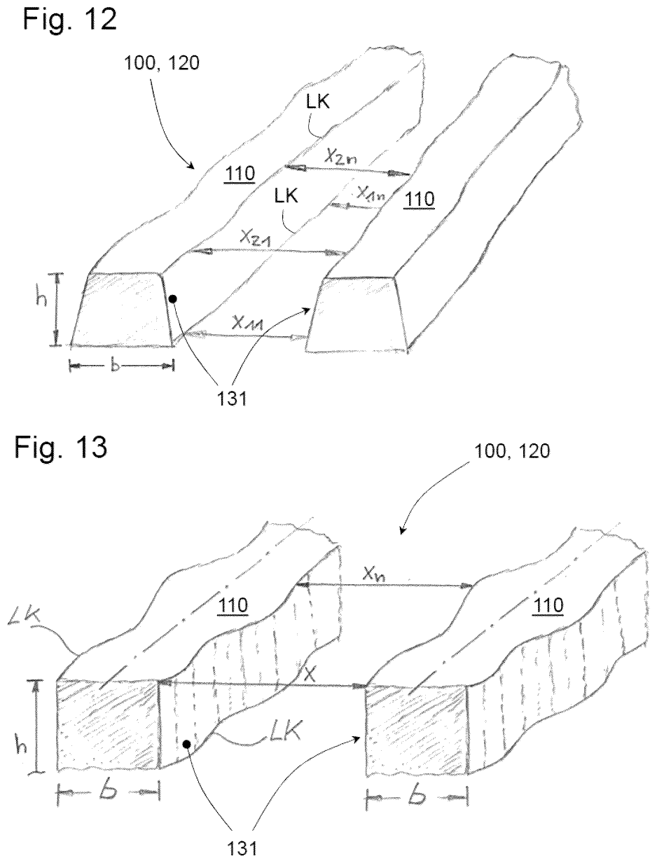

FIG. 12 shows a schematic perspective representation of a turn section with two adjacent turns according to a fourth embodiment of the invention, with a spacing varying along the upper and lower longitudinal edges in each case,

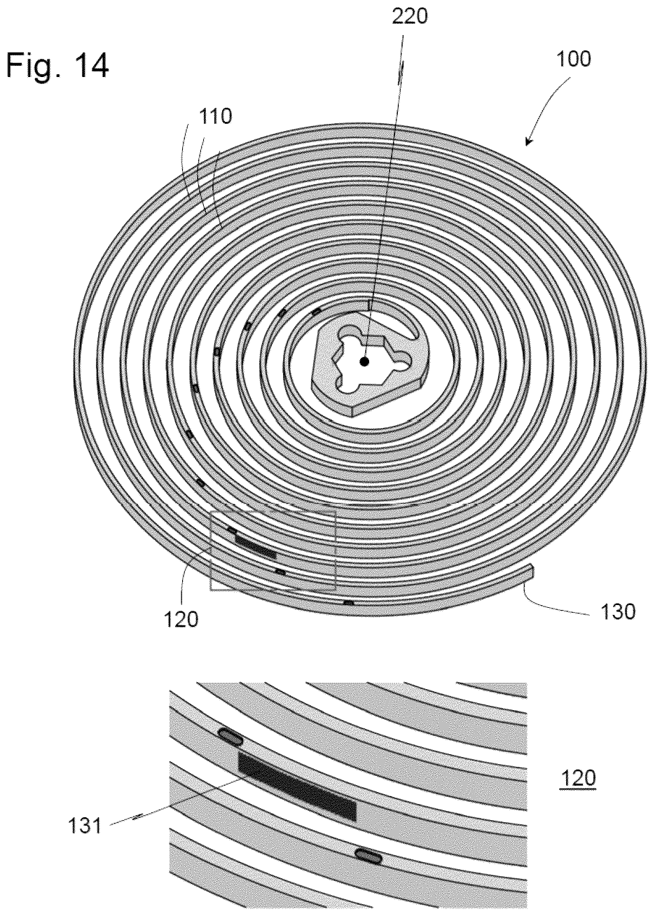

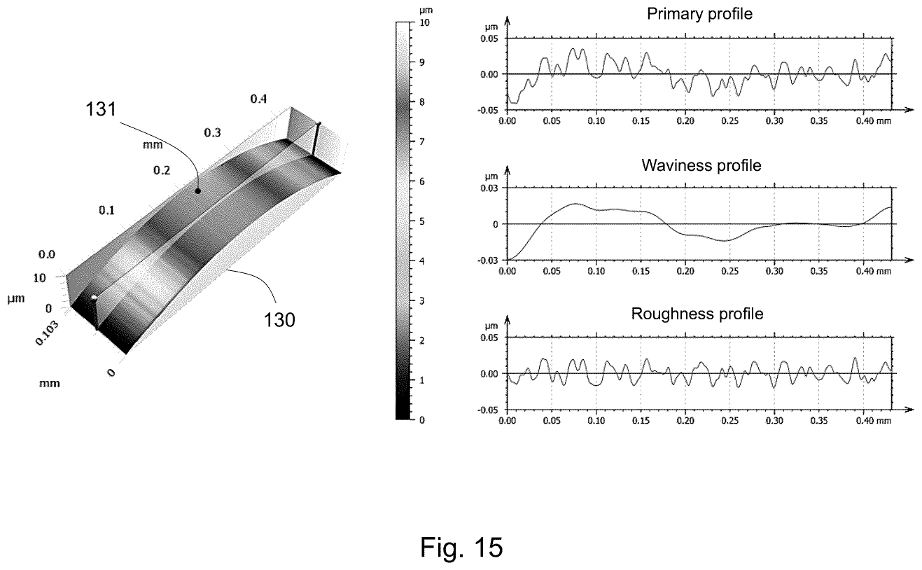

FIG. 13 shows a schematic perspective representation of a turn section with two adjacent turns according to a fifth embodiment of the invention, with a spacing constant over the height of the side surfaces and varying along the turn section,

FIG. 14 shows a perspective representation of a spiral spring according to a sixth embodiment of the invention, in a position deflected by half the oscillation width and with a side surface of the spiral blade in an enlarged representation,

FIG. 15 shows a visual representation of the metrologically captured surface finish of the enlarged side surface of FIG. 14, as well as the associated roughness, waviness and primary profile along the measuring section or the course of a turn of the spiral blade, and in

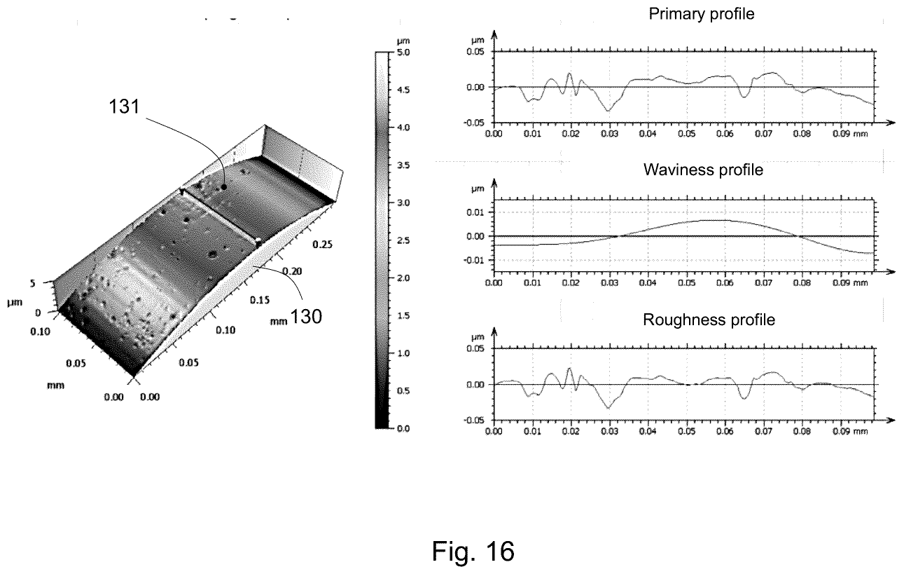

FIG. 16 shows an optical representation of the metrologically captured surface finish of the enlarged side surface of FIG. 14, as well as the associated roughness, waviness and primary profile along the height of the spiral blade.

The figures are merely exemplary in nature and serve to increase the understanding of the invention. Same elements are provided with the same reference numerals.

FIG. 1 shows a perspective representation of an oscillatory system 200 for mechanical movements known from the prior art. Oscillating system 200, also referred to as a balance wheel, comprises, as essential components, an oscillating body 210, here formed as a flywheel, and a spiral spring 100. Oscillating body 210 serves as an oscillating weight and is rotatably mounted about an axis of rotation 220. Spiral spring 100 is attached with its inner turn end 140 to an inner spring fastener 230 and with its outer turn end 150 to an outer spring retaining element 240. In between, spiral blade 130, which is rectangular in cross section, extends in a spiral course with several turns 110, which form the active oscillation section of spiral spring 100. For clocking the movement, the force coming from the barrel is transferred to oscillation system 200, so that spiral spring 100 oscillates as evenly as possible around its tension-free central position. When leaving the central position, oscillating body 210 brings about pretensioning of spiral spring 100, whereby a restoring torque is generated, which causes spiral spring 100 to return to its central position. This imparts kinetic energy to oscillating body 210, causing spiral spring 100 to oscillate in the other direction beyond its central position. Spiral spring 100 oscillates back and forth once according to its oscillation width. Oscillation widths of flat spiral springs for mechanical movements are usually 200° to 300°.

FIG. 2 shows a perspective representation of spiral spring of FIG. 1 in its tension-free central position. This is shown using the purely illustrative markings on turns 110. The markings are only present in the drawing and do not represent part of actual spiral spring 100. The oscillation width of about 220° within which spiral spring 100 moves around the central position is also shown as an example.

FIG. 3 shows a schematic, radial sectional view of two adjacent turns 110 of spiral blade 130 of spiral spring 100 of FIGS. 1 and 2. It can be clearly seen that spiral blade 130 forming individual turns 110 has a rectangular cross section with a height h and a width b. Height h, width b and spacing x between adjacent turns 110 are constant along the spiral course of spiral blade 130. For example, height h can be a value between 120 μm and 140 μm, width b can be a value between 25 μm and 40 μm, and spacing x can be a value between 80 μm and 200 μm.

FIG. 4 shows a top view of spiral spring 100 of FIGS. 1 to 3 in a position deflected by half the oscillation width. During the oscillatory movement, the direction of which is indicated by an arrow in the drawing, individual turns 110 follow their respective circular paths and move around the center or the axis of rotation 220. Based on the illustrative marking, it can be clearly seen that within a turn section 120, mutually adjacent turns 110 are subject to a relative movement during the oscillatory movement of spiral spring 100, i.e., they are deflected relative to one another by a spacing running along the corresponding circular path. In the position shown here, spiral spring 100 is at its reversal point UP after a half-oscillation, so that adjacent turns 110 are deflected relative to one another by a maximum amount, which corresponds to the angular displacement β, which is also shown. Typical values for the angular displacement β range from 5° to 30°.

FIG. 5 shows the course of a full oscillation of spiral spring 100 based on its deflection about its tension-free central position 0. Also shown are the reversal points UP, where the direction of the oscillation is reversed. Spiral spring 100 is first deflected from tension-free central position 0 in a first direction until the maximum deflection at the reversal point UP is reached and then returns in the opposite, second direction to tension-free central position 0 (half-oscillation). One oscillation is complete after tension-free central position 0 has been passed in the second direction, and spiral spring 100 returns to tension-free central position 0 again following the first direction following another reversal of direction at the reversal point UP. Individual turns 110 follow a corresponding movement along their respective circular paths, resulting in relative movement causing the angular displacement β (see FIG. 4) between adjacent turns 110 in each case.

According to the invention, the oscillation width of the spiral spring 100 should now be determined using an optical measuring method based on this angular displacement β. For this purpose, as shown in FIG. 6, optical measuring equipment 160, for example. light transmitters and/or light receivers, is aligned with a respective turn section 120, preferably vertically from above or below, i.e. parallel to axis of rotation 220 or to height h of the spiral blade, or obliquely, i.e. at an angle greater than or less than 90°, here for example about 45° with axis of rotation 220 or height h. The arrangement of optical measuring equipment 160 shown here is merely an example. A single optical measuring equipment 160 is sufficient to carry out the measuring method according to the invention.

Optical measuring equipment 160 is used to monitor the respective turn section 120, with the deflection of adjacent turns 110 relative to one another being captured optically. spacing x between adjacent turns 110 within at least one turn section 120 serves as a benchmark or reference for optical measuring equipment 160. For this purpose, spacing x in the longitudinal direction of turns 110, i.e. following the spiral course, must not be constant, otherwise the relative movement would not be optically detectable. A “visualization” of the relative movement or deflection of adjacent turns 110 relative to one another is achieved by varying their spacing x along the turn section 120. By optical scanning by means of measuring equipment 160, angular displacement β of turns 110, which shift relative to one another during dynamic operation, i.e. during the oscillatory movement, can be reliably recorded at a varying spacing x.

FIG. 7 shows a schematic representation of the oscillation-related change in turn spacing WA during the oscillatory movement of spiral spring 100. During the oscillation, spiral spring 100 contracts and expands due to the oscillation, spiral spring 100 “breathes”. This causes a change in turn spacing WA following the oscillation period. This oscillation-related change in turn spacing WA inevitably occurs when spiral springs 100 contract or expand, and should therefore preferably be taken into account when optically capturing angular displacement β (see FIG. 4) based on the spacing varying according to the invention, which is due to the component geometry, in particular the geometry of adjacent turn sections 120.

Hence, FIG. 8 shows a schematic representation of an overlay of the oscillation-related change in turn spacing WA and the variance of the spacing x according to the invention caused by the component geometry illustrating to exemplary spacings x₁ and xₙ. For the average spacing x, which, according to the invention, should vary between values x₁ and xₙ, the spacing between turns 110 in the rest position of spiral spring 100 is therefore preferably not taken as a basis, but rather turn spacing WA of spiral spring 100, which changes dynamically during the oscillatory movement.

In the case of a spiral spring 100 according to the invention, which is suitable for use in the optical measuring method according to the invention, it is therefore necessary that the spacing x between adjacent turns 110 varies at least along a measuring path that corresponds at least to angular displacement β. Preferably, the variance of the spacing is at least 0.02%, 0.05% or 0.1%, more preferably at least 0.25% or at least 0.3% and at most 1.5%, and more preferably at most 1.0%. An angular displacement β of, for example, 5°, will result in a minimum length of the measuring section of 100.0 μm, an angular displacement β of, for example, 30°, will result in a minimum length of 900.0 μm.

Preferably, the varying spacing x is brought about by optimization of the geometry of mutually facing side surfaces 131 of adjacent turns 110 of spiral spring 100. FIG. 9 shows a schematic perspective representation of a turn section 120 with two adjacent turns 110 according to a first embodiment of the invention. Mutually facing side surfaces 131 of adjacent turns 110 have a transition area ÜB with an average edge rounding of, for example, 2.0 μm on their respective upper longitudinal edge LK. Along turn section 120, i.e. along the spiral course, and at least along the measuring section, the edge rounding of the transition area OB varies here, for example, by at least 25%, which corresponds to a deviation of +/−0.5 μm around the mean value. This in turn results in a range of 1.5 μm to 2.5 μm, within which the edge rounding along the measuring section or the course of the turn varies. Such a geometry of side surfaces 131 also brings about a variance in average spacing x₂, which, here in the area of the upper longitudinal edge LK along the measuring section, preferably varies continuously or continuously within the value series x₂₁-x₂ₙ.

Specifically, for example, value x₂₃ could be larger than x₂₁ and x₂₄ could be smaller than x₂₃, spacing x₂ then first increases and then decreases. Alternatively, a continuous increase or decrease in the spacing x₂ along the measuring section is of course also conceivable. In the present exemplary embodiment, the spacing x₂ varies exclusively in the area of the upper longitudinal edge LK; accordingly, the measuring height for the optical measuring method is also set at the upper longitudinal edge LK.

The designation “upper” and “lower” longitudinal edge LK refers to the installation position of spiral spring 100 or the movement, for example in a clock or in a chronograph, viewed from the back in the direction of the dial.

FIG. 10 shows a schematic perspective representation of a turn section 120 with two adjacent turns 110 according to a second embodiment of the invention. Mutually facing side surfaces 131 here have a geometry that is concave over the height h. The concavity is formed here primarily in the lower subsection of side surfaces 131, as a result of which spacing x₂ of adjacent turns 110 in the area of the upper longitudinal edge LK along the measuring section is constant and larger than the average spacing x₁ in the area of the lower longitudinal edge LK. By varying the concavity along the measuring section or along turn section 120, a preferably continuously changing lower longitudinal edge LK can be formed. Such a geometry of side surfaces 131 in turn brings about a variance in the average spacing x₁, this time in the area of the lower longitudinal edge LK. Along the measuring section, the average spacing x₁ varies preferably steadily or continuously within value series x₁₁-x₁ₙ. The measuring height for the lower longitudinal edge LK is also determined accordingly.

FIG. 11 shows a schematic perspective representation of a third embodiment of the invention. Turn section 120 shown here comprises two adjacent turns 110, each with oblique, mutually facing side surfaces 131. Due to the oblique course of side surfaces 131, which deviates from vertical, side surfaces 131 include a so-called opening angle α, which is formed to vary along the measuring section or along the spiral course and varies by an average opening angle α within the value series α₁-αₙ. The average opening angle α can be 5°, for example, the variance is in particular at least +/−0.1°, as a result of which the opening angle α then varies at least between 4.9° and 5.1° within the value series α₁-αₙ. The geometric configuration of the opening angle α brings about, for example, a spacing x₂ in the area of the upper longitudinal edge LK that varies within the value series x₂₁-x₂ₙ, whereas the spacing x₁ in the area of the lower longitudinal edge LK can be constant along the measuring section.

Optionally, as shown in a schematic perspective representation in FIG. 12, a varying opening angle α can also be chosen by the geometry of side surfaces 131 so that the spacing x₁, x₂ of adjacent turns 110 both in the area of the upper longitudinal edge LK, within value series x₂₁-x₂ₙ, as well as in the area of the lower longitudinal edge LK, varies within value series x₁₁-x₁n. This can be achieved in particular by an irregular, varying course of the respective longitudinal edge LK.

The geometry of mutually facing side surfaces 131 can also be formed such that spacing x between adjacent turns 110 is constant over entire height h of spiral blade 130 and varies along the measuring section. Such a fourth embodiment of the invention can finally be seen in FIG. 13 in a schematic perspective representation of a turn section 120. This design has the particular advantage that the measuring height for the optical measuring method can be chosen at any height h of the spiral blade 130.

FIG. 14 shows a schematic perspective representation of a spiral spring 100 according to a sixth embodiment of the invention. As shown by the purely illustrative markings on turns 110, spiral spring 100 is in a position deflected by half the oscillation width. A section of a turn section 120 and side surface 131 of spiral blade 130 visible therein are illustrated in an enlarged representation. Along the course of the spiral, the length of side surface 131 corresponds at least to angular displacement β (see FIG. 4) and, in the direction of axis of rotation 220, preferably corresponds to height h of spiral blade 130 and at least 50.0 μm.

Each of FIGS. 15 and 16 shows a visual representation of the metrologically captured surface finish of enlarged side surface 131 of spiral blade 130 of FIG. 14, and the associated roughness (bottom), waviness (middle) and primary profile (top). The section of side surface 131 shown in FIG. 15 and captured metrologically extends 0.45 mm along the course of the turn. The associated roughness profile shows the course of the roughness depth R_{z} as a 3rd order deviation from the surface target value over the measuring spacing of 0.45 mm. The amount of the maximum change in the roughness depth R_{z} is 0.042 μm.

It can also be clearly seen that the intervals in the roughness profile within which there are fluctuations in the roughness depth R_{z} between positive and negative values, i.e. the zero line is passed, are significantly smaller than in the waviness profile. In other words, the roughness profile contains a many times higher number of intersection points with the zero line than the waviness profile over the same measuring spacing of 0.45 mm in this case. The waviness profile shows the course of wave depth Wₜ as a 2nd order deviation from the surface target value also over the measuring section of 0.45 mm of the course of the turn. The amount of the maximum change in the wave depth Rₜ is 0.46 μm.

In the primary profile, an overlay of the waviness profile and the roughness profile is again plotted over the same measuring spacing of 0.45 mm. It is easy to see that the course of the roughness profile follows the 2nd order deviations brought about by the waviness. In the primary profile and along the surface of the workpiece actually measured, i.e., in the present case side surface 131 of spiral blade 130, the course of the waviness profile consequently forms the zero line of the roughness profile. The zero line of the waviness profile corresponds to the actual surface, i.e. the desired shape, and in the present exemplary embodiment to the steady curvature of side surface 131 of spiral blade 130.

The waviness of one or both of mutually facing side surfaces 131 of spiral blade 130 along a measuring section corresponding at least to angular displacement β and along the course of the turn, which corresponds to the waviness profile shown in FIG. 15, brings about a variance of the spacing x according to the invention, which is suitable as a reference for capturing angular displacement β by means of optical measuring equipment and for determining the oscillation width and/or frequency.

Optionally, a corresponding waviness can also be configured along height h of one or both of mutually facing side surfaces 131 of spiral blade 130. The section of side surface 131 shown in FIG. 16 and captured metrologically extends 0.3 mm along the course of the turn. This time the measuring section runs along height h of spiral blade 130 and has a length of 0.1 mm. The associated roughness profile shows the course of the roughness depth R_{z} as a 3rd order deviation or the course of waviness Wₜ as a 2nd order deviation from the surface target value over the measuring spacing of 0.1 mm along height h. In this case, as a result, the zero line of the roughness, waviness and primary profile corresponds to the height of a cross section of the spiral blade (see, for example, FIG. 3). In this case, the amount of the maximum change in roughness depth R_{z} is 0.054 μm, the amount of the maximum change in wave depth Wₜ is 0.013 μm. The crater-like depressions visible in the surface of the section of spiral blade 130 are part of the roughness profile.

### LIST OF REFERENCE NUMERALS

100 spiral spring
110 turn
120 turn section
130 spiral blade
131 side surface of the spiral blade
140 inner turn end
150 outer turn end
160 optical measuring equipment
200 oscillation system
210 oscillating body
220 axis of rotation
230 inner spring fastener
240 outer spring retaining element
b width of the spiral blade
h height of the spiral blade
x spacing between adjacent turns
UP reversal point
WA oscillation-related turn spacing
Wₜ wave depth
R_{z} roughness depth
0 tension-free central position
α opening angle
β angular displacement

1. An optical measuring method for the determination of an oscillation width (SW) of a spiral spring (100) with several turns (110) which extend along respective circular paths following a spiral, wherein
a deflection of adjacent turns (110) relative to one another and along their respective circular paths is optically detected in at least one turn section (120), during oscillatory movement of the spiral spring (100), based on a variance of spacing (x) between the adjacent turns (110) along the turn section (120),
a corresponding angular displacement (β) of the adjacent turns (110) relative to one another is determined based on a maximum deflection, and
based on the angular displacement (β), the oscillation width or frequency of the spiral spring (100) is determined mathematically.

2. The measuring method according to claim 1,
characterized in that,
for optical capture of the deflection of adjacent turns (110), at least one turn section (120) is specified, within which a variance of the spacing (x) between the adjacent turns (110) is at least 0.02%, at least along a measuring section corresponding to the angular displacement (β).

3. The measuring method according to claim 1,
characterized in that
the spacing (x) is defined as a radial spacing (x) between the adjacent turns (110) along a radius of the spiral spring (100) starting from a side surface (131) of one of the turns (110) towards the opposite side surface (131) of the other turn (110).

4. The measuring method according to claim 3,
characterized in that
the variance of the spacing (x) between the adjacent turns (110) along the turn section (120) is captured at one or more measuring heights defined in relation to the height (h) of the spiral spring (100), and the measuring heights are specified based on the geometry of the mutually facing side surfaces (131).

5. The measuring method according to claim 1,
characterized in that
the oscillation frequency is determined based on an oscillation period of the spiral spring (100), wherein a one-time deflection of adjacent turns (110) relative to one another by the angular deviation (β) corresponds to a half-oscillation of the spiral spring (100).

6. The measuring method according to claim 5,
characterized in that
a target value/actual value comparison is carried out, based on the determined oscillation width or frequency, wherein the determined oscillation width and/or frequency corresponds to the actual value and this actual value is compared with a corresponding, pre-specified target value.

7. A spiral spring (100) with several turns (110) which extend along respective circular paths forming a spiral, wherein the spiral spring (100) can be stimulated to an oscillatory movement, with adjacent turns (110) being deflected relative to each other along their respective circular paths by an angular displacement (β),
characterized in that
the spacing (x) between the adjacent turns (110) varies at least along a measuring section corresponding to the angular displacement (β).

8. The spiral spring (100) according to claim 7,
characterized in that
the varying spacing (x) is brought about by the geometry of the mutually facing side surfaces (131) of the adjacent turns (110) of the spiral spring (100), and the spacing varies both along the measuring section and along the height (h) of the mutually facing side surfaces (131) of the spiral spring (130).

9. The spiral spring (100) according to claim 7,
characterized in that
the varying spacing (x) is brought about by the geometry of the mutually facing side surfaces (131) of the adjacent turns (110) of the spiral spring (100), wherein the geometry of the mutually facing side surfaces (131) is formed such that the spacing (x) between the adjacent turns (110) is constant over the entire height (h) of the mutually facing side surfaces (131) and varies along the measuring section.

10. The spiral spring (100) according to claim 8,
characterized in that
the variance of the spacing (x) between the adjacent turns (110) along the measuring section is at least 0.02%, or along the height (h) is at least 0.01% and at most 2.0%.

11. The spiral spring (100) according to claim 7,
characterized in that
the spacing (x) varies continuously or steadily along the measuring section.

12. The spiral spring (100) according to claim 11,
characterized in that
a surface finish of one or both of the mutually facing side surfaces (131) is configured with a waviness which brings about a variance of the spacing (x) along the measuring section or along the height (h).

13. The spiral spring (100) according to claim 12,
characterized in that
a roughness depth R_{z} of the mutually facing side surfaces (131) is at most 0.5 μm.

14. The spiral spring (100) according to claim 13,
characterized in that
the waviness corresponds to a 2nd order shape deviation defined according to DIN 4760:1982-06 or the roughness R_{z} corresponds to a 3rd or 4th order shape deviation defined according to DIN 4760:1982-06.

15. The spiral spring (100) according to claim 7,
characterized in that
the varying spacing (x) is brought about by the geometry of the mutually facing side surfaces (131) of the adjacent turns (110) of the spiral spring (100), wherein the geometry of the mutually facing side surfaces (131) is formed such that the spacing (x) between the turns (110) varies either over the entire height (h) of the mutually facing side surfaces (131) or only at a certain height (h) or a certain height range along the measuring section.

16. The spiral spring (100) according to claim 15,
characterized in that
the spacing (x) between the adjacent turns (110) in an area of the lower longitudinal edge (LK) of the mutually facing side surfaces (131) deviates from the spacing (x) between the adjacent turns (110) in an area of the upper longitudinal edge (LK) of the mutually facing side surfaces (131), the spacings (x) in the area of the upper longitudinal edge (LK) or in the area of lower longitudinal edge (LK) varying along the measuring section.

17. The spiral spring (100) according to claim 16,
characterized in that
the geometry of the mutually facing side surfaces (131) is formed following a concave or convex course over the height (h) of one or both side surfaces (131), the concave or convex courses varying along the measuring section.

18. The spiral spring (100) according to claim 16,
characterized in that
the geometry of the mutually facing side surfaces (131) is formed to include an opening angle (a) in between, the opening angle (a) varying along the measuring section.

19. The spiral spring (100) according to claim 16,
characterized in that
the geometry of the mutually facing side surfaces (131) of the turns (110) in the area of the upper or lower longitudinal edges (LK) is formed such that the longitudinal edges (LK) have an irregular course, at least along the measuring section.
